(19) United States
(12) Patent Application Publication
(10) Pub. No.: US 2006/0132324 A1
(43) Pub. Date: Jun. 22, 2006

(54) Electronic apparatus and method for controlling the same

(75) Inventors: Tomoyuki Fukuda, Kawasaki-shi (JP); Shinichi Matsuki, Kodaira-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/285,150

(22) Filed: Nov. 23, 2005

(30) Foreign Application Priority Data
Dec. 17, 2004 (JP) 2004-366496

(51) Int. Cl. H02J 13/00

(52) U.S. Cl. 340/825.52; 340/825.69; 340/825.72; 340/825.25; 340/3.7

(57) ABSTRACT

The present invention determines whether received operation information is addressed to its own apparatus and, if such is the case, executes processing based on a command included in the operation information and, otherwise, packetizes the operation information and outputs it to a network.

### CROSS-REFERENCE TO RELATED APPLICATIONS

This application is based upon and claims the benefit of priority from prior Japanese Patent Application No. 2004-366496, filed Dec. 17, 2004, the entire contents of which are incorporated herein by reference.

### BACKGROUND OF THE INVENTION

1. Field of the Invention

The present invention relates to an electronic apparatus that can be remote-controlled by a remote controller. It also relates to an electronic apparatus controlling method for controlling an electronic apparatus by using a remote controller.

2. Description of the Related Art

It is known that presently a remote-control system installed in a home-use electronic apparatus is mainly of a wireless type that the electronic apparatus receives operation information transmitted by infrared light from a remote controller.

In this type of remote-control system, however, operation information sent from the remote controller needs to be received by the electronic apparatus, so that an area within which the electronic apparatus can be remote-controlled is restricted as a matter of course.

Jpn. Pat. Appln. KOKAI Publication No. 10-155188 discloses a configuration that if control information for remote-control operations is received by any one of apparatuses connected to a network, the apparatus determines whether the control information is addressed to its own or any other apparatuses and, if it is addressed to any of the other apparatuses, transmits the control information to the network.

### BRIEF SUMMARY OF THE INVENTION

According to one aspect of the present invention, there is provided an electronic apparatus comprising: a first reception section configured to receive operation information; a first determination section configured to determine whether operation information received by the first reception section is addressed to itself based on an apparatus code included in the operation information; an execution section configured to execute processing based on a command included in the operation information if the first determination section determines that the operation information is addressed to itself; and a first output section configured to packetize the operation information and output it to a network if the first determination section determines that the operation information is not addressed to itself.

According to another aspect of the present invention, there is provided an electronic apparatus controlling method comprising: a first step of receiving operation information; a second step of determining whether operation information received by the first step is addressed to itself based on an apparatus code included in the operation information; a third step of executing processing based on a command included in the operation information if the second step determines that the operation information is addressed to itself; and a fourth step of packetizing the operation information and output it to a network if the second step determines that the operation information is not addressed to itself.

### BRIEF DESCRIPTION OF THE SEVERAL VIEWS OF THE DRAWING

FIG. 1 is a block diagram of an outline of a remote-control system according to one embodiment of the present invention;

FIG. 2 is a block diagram of a signal processing system of an electronic apparatus used in the remote-control system of the present embodiment;

FIG. 3 is an explanatory diagram of operations of a light reception section in the electronic apparatus used in the remote-control system of the present embodiment;

FIG. 4 is an explanatory diagram of a transmit packet which is sent to an LAN from the electronic apparatus used in the remote-control system of the present embodiment;

FIG. 5 is a flowchart of one example of a processing operation of the electronic apparatus used in the remote-control system of the present embodiment; and

FIG. 6 is a flowchart of another example of the processing operation of the electronic apparatus used in the remote-control system of the present embodiment.

### DETAILED DESCRIPTION OF THE INVENTION

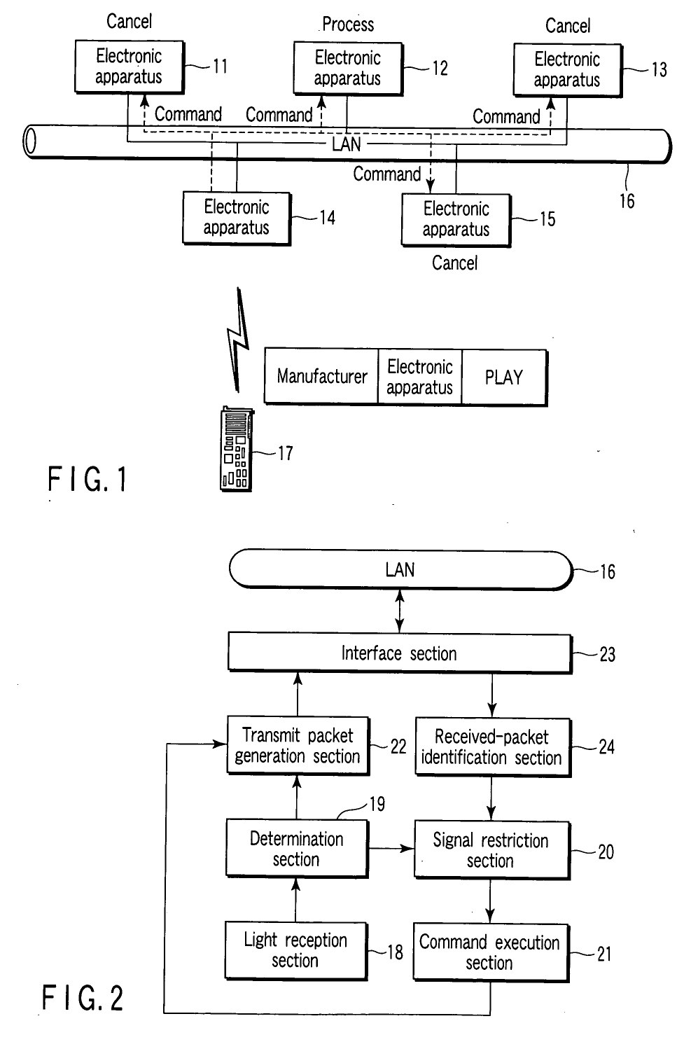

The following will describe one embodiment of the present invention with reference to drawings. FIG. 1 shows an outline of a remote-control system according to the present embodiment. That is, a plurality of (five in the figure) electronic apparatuses 11-15 is connected to each other via a local area network (LAN) 16 in such a manner that they can transmit data to each other.

In this configuration, by operating a remote controller 17 that remote-controls the electronic apparatus 12, operation information sent by infrared light therefrom is received by another electronic apparatus 14. This operation information sent from the remote controller 17 includes a manufacturer code of the electronic apparatus 12, an electronic apparatus code, and a command (e.g., PLAY).

Then, the electronic apparatus 14 determines whether the received operation information is addressed to its own apparatus 14 and, if such is the case, processes the command. In this case, the operation information the electronic apparatus 14 has received is not addressed to its own apparatus 14, so that the electronic apparatus 14 sends the received operation information to the LAN16.

Accordingly, the other electronic apparatuses 11-13 and 15 each receive the operation information via the LAN16 and determine whether the received operation information is addressed to their own apparatuses. In this case, the electronic apparatuses 11, 13, and 15 each determine that the received operation information is not addressed to their own apparatuses 11, 13, and 15 and, therefore, cancel the operation information.

Only the electronic apparatus 12 determines that the received operation information is addressed to its own apparatus 12 and processes the command.

Accordingly, it is possible to remote-control the electronic apparatus 12 without permitting the operation information sent from the remote controller 17 to be received by the electronic apparatus 12, so that a remote-controllable area can be expanded greatly, to facilitate handling for a user.

It is to be noted that even in a case where the operation information sent from the remote controller 17 is selectively permitted to be received by any other electronic apparatus 11, 13, or 15, by performing the same operations as above, the electronic apparatus 12 can acquire the operation information via the LAN16 and process the command.

FIG. 2 shows a signal processing system of the electronic apparatus 14 for realizing the above-described remote-control functions. It is to be noted that the signal processing systems of the other electronic apparatuses 11-13 and 15 are of the same configuration as that of the electronic apparatus 14 and so their explanation is omitted.

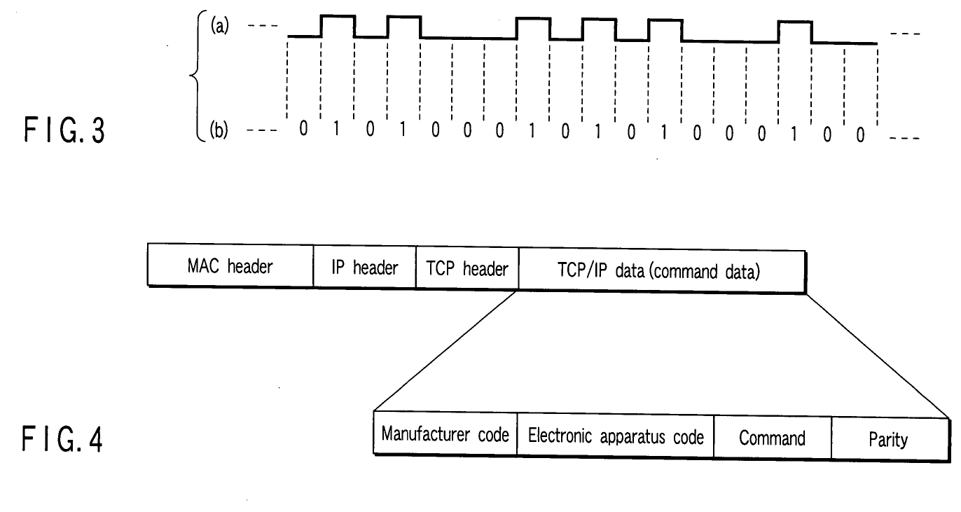

That is, the control information sent by the infrared light from the above-described remote controller 17 is received by a light reception section 18. This light reception section 18 receives an infrared light pulse signal (physical signal) such as shown in, for example, symbol (a) of FIG. 3 as the operation information sent from the remote controller 17 and converts it into a digital signal such as shown in symbol (b) of FIG. 3.

Then, the operation information thus converted into the digital signal by this light reception section 18 is supplied to a determination section 19. This determination section 19 determines whether the input operation information is addressed to its own apparatus 14.

In this case, the determination section 19 determines that the input operation information is addressed to its own apparatus 14 if a manufacturer code or an electronic apparatus code included in the input operation information agrees with that stored in its own apparatus 14 and, otherwise, determines that it is not addressed to its own apparatus 14.

In a case where the determination section 19 determines that the input operation information is addressed to its own apparatus 14, it outputs a command included in it to a command execution section 21 via a signal restriction section 20 so that the command may be executed.

If the determination section 19 determines that the input operation information is not addressed to its own apparatus 14, it outputs the operation information to a transmit packet generation section 22. This transmit packet generation section 22 converts the input operation information into a common protocol in the LAN16 and sends it out via an interface section 23 to the LAN16.

FIG. 4 shows one example of a transmit packet which is thus sent to the LAN16. This transmit packet is comprised of a media access control (MAC) header, an Internet protocol (IP) header, a transmission control protocol (TCP) header, and a TCP/IP data (command data). Moreover, this TCP/IP data stores a manufacturer code, an electronic apparatus code, and a command that are included in operation information as well as a parity added to each of them.

On the other hand, in a manner similar to the above, a transmit packet sent to the LAN16 from any of the other apparatuses 11-13 and 15 is supplied via the above-described interface section 23 to a received-packet identification section 24. This received-packet identification section 24 identifies whether a received transmit packet is addressed to its own apparatus 14.

In this case, the received-packet identification section 24 determines that the transmit packet is addressed to its own apparatus 14 if the manufacturer code or the electronic apparatus code included in the received transmit packet agrees with that stored in its own apparatus 14 and, otherwise, determines that it is not addressed to its own apparatus 14 and cancels it.

If the received-packet identification section 24 thus determines that a received transmit packet is addressed to its own apparatus 14, it outputs a command included in it to the command execution section 21 via the signal restriction section 20 so that the command may be executed.

In this case, the command execution section 21 outputs, to the transmit packet generation section 22, return information indicative of a response (optical signal, voice, video, etc.) to the effect that the command has been executed or a status (power-ON etc.) after the command is executed.

Then, the transmit packet generation section 22 packetizes the return information supplied from the command execution section 21 and sends it to the LAN 16 via the interface section 23 so that it may be sent to any one of the source electronic apparatuses 11-13 and 15 that has earlier sent the transmit packet containing the operation information to the LAN16.

In this case, if the above-described determination section 19 determines that operation information supplied from the light reception section 18, that is, operation information sent from the remote controller 17 is addressed to its own apparatus 14, it outputs a command included in it to the command execution section 21 via the signal restriction section 20 while imposing restriction on the signal restriction section 20 so that a command output from the received-packet identification section 24 may not be supplied to the command execution section 21.

That is, in case where the remote controller 17 is operated for the electronic apparatus 12 to be remote-controlled thereby, there is a possibility that operation information sent from the remote controller 17 may be received not only by the electronic apparatus 12 but also by any other electronic apparatuses 11 and 13-15.

In this case, in the electronic apparatus 12, a command obtained from the remote controller 17 and a command obtained from the operation information sent to the LAN16 from any one of the other electronic apparatuses 11 and 13-15 may possibly be supplied serially to the command execution section 21 with a time difference therebetween, thereby giving rise to malfunctioning in execution of the commands.

Therefore, in the case where operation information sent from the remote controller 17 is addressed to its own apparatus 12, a command included in the operation information is supplied to the command execution section 21 while inhibiting a command supplied via the LAN16 from any other apparatuses 11 and 13-15 from being provided to the command execution section 21, thereby preventing malfunctioning in execution of the commands.

FIG. 5 shows a flowchart that summarizes processing operations of the electronic apparatus 14 when it has received operation information sent from the remote controller 17. This processing is started by the light reception section 18 when it receives operation information sent from the remote controller 17 (step S1).

Then, in step S2, the determination section 19 decodes the received operation information and, in step S3, determines whether the operation information is addressed to its own apparatus 14. If it is determined that the operation information is not addressed to its own apparatus 14 (NO), in step S4 the transmit packet generation section 22 generates a transmit packet containing the operation information and, in step S5, sends it out to the LAN16, to end processing (step S8).

If it is determined in step S3 that the operation information is addressed to its own apparatus 14 (YES), in step S6 the determination section 19 and the signal restriction section 20 conduct control so that a command output from the received-packet identification section 24, that is, a command received via the LAN16 may not be supplied to the command execution section 21.

In step S7, the determination section 19 and the signal restriction section 20 conduct control so that a command included in the operation information sent from the remote controller 17 may be supplied to the command execution section 21, so that the command is executed, to end the processing (step S8).

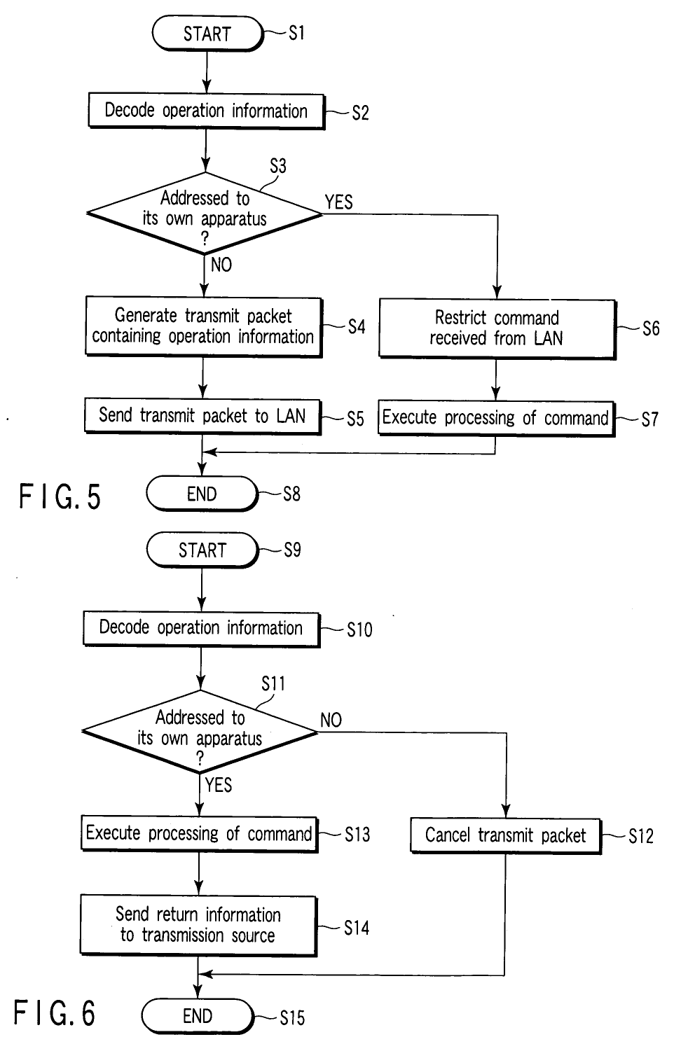

FIG. 6 shows a flowchart that summarizes processing operations of the electronic apparatus 14 when it has received a transmit packet from the LAN16. This processing starts (step S9) when a transmit packet sent from any one of the other apparatuses 11-13 and 15 to the LAN16 is received by the received-packet identification section 24.

Then, in step S10, the operation information included in the transmit packet received by the received-packet identification section 24 is decoded and, in step S11, determined whether it is addressed to its own apparatus 14. If it is determined that the operation information is not addressed to its own apparatus 14 (NO), the transmit packet is cancelled by the received-packet identification section 24 in step S12, to end the processing (step S15).

If it is determined in step S11 that the operation information is addressed to its own apparatus 14 (YES), on the other hand, in step S13 the determination section 19 and the signal restriction section 20 conduct control so that a command included in the operation information acquired by the received-packet identification section 24 may be supplied to the command execution section 21, thereby processing the command.

Then, in step S14, return information based on the processing of the command by the command execution section 21 is generated and packetized and sent via the LAN 16 to any one of the source electronic apparatuses 11-13 and 15 that has earlier sent the transmit packet containing the operation information to the LAN16, thereby ending the processing (step S15).

The following will describe one example of a specific type of using such a remote-control system as described above. For example, if a remote controller in an air conditioner installed in a sleeping room is operated as directed to a TV receiver installed in a living room so that its power may be turned ON. Then, the remote controller sends an electronic code to the effect of being air conditioner, a command code indicative of power-ON, etc.

The TV receiver receives the electronic apparatus code sent from the remote controller and identifies that this code does not agree with its own electronic code of “TV RECEIVER” and, therefore, determines that relevant operation information is not addressed to itself. The code thus determined not to be addressed to itself is packetized according to a protocol such as TCP/IP, added a MAC header, and broadcasted to a home network.

The packet thus broadcast is distributed to all of electronic apparatuses on the home network, which apparatuses except the air conditioner installed in the sleeping room identify that the packet is not to be processed by themselves and cancel it.

The air conditioner in the sleeping room recognizes the electronic apparatus code of “AIR CONDITIONER” in the packet and processes a command (power-ON) included in the same packet.

When having completed the processing of the command, the air conditioner packetizes return information such as post-processing response or status data and transmits it via the home network to an address of the TV receiver that has earlier transmitted the packet.

When having received the return information, the TV receiver generates a signal such as sound or light or displays a status of the air conditioner through on-screen display (OSD) on a screen in condition where it is overlapped.

By thus using the above-described practical example on the home network, a user can turn on power of the air conditioner in the sleeping room while staying in the living room.

Further, the remote controllers of the electronic apparatuses connected to the home network can all be operated in condition where they are directed in the same direction. That is, the remote controllers of a video cassette recorder (VCR), a stereo audio apparatus, an air conditioner, etc. connected to the home network can all be controlled by operating them in condition where they are directed to the TV receiver rather than directing them in directions of their respective apparatuses.

According to a remote-control system according to the above-described embodiment, even if a user is distant from an electronic apparatus which he wishes to operate, he only needs to have its remote controller in his own hands in order to remote-control that target electronic apparatus easily by operating the remote-controller in condition where it is directed to any other electronic apparatus. Further, all of the remote controllers can be operated in condition where they are directed in the same direction, thus facilitating handing for the user.

The present invention is not limited to the embodiment explained above, but can be embodied by modifying its components in a variety of manners without departing from a gist of the present invention in a phase of execution. Further, by appropriately combining a plurality of components disclosed in the above embodiment, a variety of inventions can be formed. For example, some of all of the components given in the embodiment can be eliminated. Further, components related to different embodiments can be combined appropriately.

What is claimed is:

1. An electronic apparatus comprising:
a first reception section configured to receive operation information;
a first determination section configured to determine whether operation information received by the first reception section is addressed to itself based on an apparatus code included in the operation information;
an execution section configured to execute processing based on a command included in the operation information if the first determination section determines that the operation information is addressed to itself; and
a first output section configured to packetize the operation information and output it to a network if the first determination section determines that the operation information is not addressed to itself.

2. An electronic apparatus according to claim 1, wherein the first reception section is configured to receive operation information sent from a remote controller.

3. An electronic apparatus according to claim 1, wherein the first output section is configured to generate a transmit packet including a MAC header, an IP header, a TCP header, and TCP/IP data and store the operation information in the TCP/IP data.

4. An electronic apparatus according to claim 1, further comprising:
a second reception section configured to receive a packet output on the network;
a second determination section configured to determine whether operation information in the packet received by the second reception section is addressed to itself based on an apparatus code included in the operation information; and
a control section configured to cancel the operation information received by the second reception section if the second determination section determines that the operation information is not addressed to itself and cause the execution section to execute processing based on a command included in the operation information received by the second reception section if the operation information received by the second reception section is determined to be addressed to itself.

5. An electronic apparatus according to claim 4, further comprising a second output section configured to generate return information based on execution of the processing of the command by the control section and output it to a transmission source of the packet via the network.

6. An electronic apparatus according to claim 4, wherein the control section is configured to conduct control so that a command included in operation information received by the second reception section may not be processed by the execution section if operation information received by the first reception section is determined by the first determination section to be addressed to itself.

7. An electronic apparatus controlling method comprising:
a first step of receiving operation information;
a second step of determining whether operation information received by the first step is addressed to itself based on an apparatus code included in the operation information;
a third step of executing processing based on a command included in the operation information if the second step determines that the operation information is addressed to itself; and
a fourth step of packetizing the operation information and output it to a network if the second step determines that the operation information is not addressed to itself.

8. An electronic apparatus controlling method according to claim 7, wherein the first step receives operation information sent from a remote controller.

9. An electronic apparatus controlling method according to claim 7, wherein the first step generates a transmit packet including a MAC header, an IP header, a TCP header, and TCP/IP data and stores the operation information in the TCP/IP data.

10. An electronic apparatus controlling method according to claim 7, further comprising:
a fifth step of receiving a packet output on the network;
a sixth step of determining whether operation information in the packet received by the fifth step is addressed to itself based on an apparatus code included in the operation information; and
a seventh step of canceling operation information received by the fifth step if the sixth step determines that the operation information is not addressed to itself and causing the third step to execute processing based on a command included in the operation information received by the fifth step if this operation information is determined to be addressed to itself.

11. An electronic apparatus controlling method according to claim 10, further comprising an eighth step of generating return information based on execution of the processing of the command by the seventh step and outputting it to a transmission source of the packet via the network.

12. An electronic apparatus controlling method according to claim 10, wherein the seventh step conducts control so that a command included in operation information received by the fifth step may not be processed by the third step if operation information received by the first step is determined by the second step to be addressed to itself.
